(19) United States
(12) Patent Application Publication
(10) Pub. No.: US 2018/0364922 A1
(43) Pub. Date: Dec. 20, 2018

(54) DYNAMIC CACHING MODE BASED ON UTILIZATION OF MIRRORING CHANNELS

(71) Applicant: NetApp, Inc., Sunnyvale, CA (US)

(72) Inventor: Randolph Sterns, Boulder, CO (US)

(21) Appl. No.: 16/110,704

(22) Filed: Aug. 23, 2018

Related U.S. Application Data
(63) Continuation of application No. 14/922,941, filed on Oct. 26, 2015.

(51) Int. Cl. G06F 3/06; G06F 11/16

(52) U.S. Cl. CPC G06F 3/0613; G06F 3/0683; G06F 3/0635; G06F 11/16

(57) ABSTRACT

A high availability storage controller monitors characteristics representative of I/O workload related to processor and mirroring channel utilization. These are input into a model of the system, which provides a threshold curve therefore. The storage controller compares the monitored characteristics against the threshold curve. In write-back mirroring mode, the storage controller determines to remain in that mode when the characteristics fall below the threshold curve and switch to write-through mode when the characteristics fall at or above the threshold curve. In write-through mode, the storage controller determines to remain in that mode when the characteristics fall at or above a lower threshold derived from the generated threshold curve and switch to write-back mirroring mode when the characteristics fall below the lower threshold. The storage controller may repeat this monitoring, comparing, and determining whether to switch over time for a feedback loop to provide a responsive and dynamic caching mode system.

### CROSS REFERENCE TO RELATED APPLICATIONS

This patent application is a continuation of U.S. application Ser. No. 14/922,941 filed Oct. 26, 2015, the disclosure of which is hereby incorporated by reference in its entirety.

### TECHNICAL FIELD

The present description relates to data storage and, more specifically, to systems, methods, and machine-readable media for dynamically changing a caching mode in a storage system for read and write operations based on a measured usage of the system.

### BACKGROUND

Some conventional storage systems include storage controllers arranged in a high availability (HA) pair to protect against failure of one of the controllers. An additional protection against failure and data loss is the use of mirroring operations. In one example mirroring operation, a first storage controller in the high availability pair sends a mirroring write operation to its high availability partner before returning a status confirmation to the requesting host and performs a write operation to a first virtual volume. The high availability partner then performs the mirroring write operation to a second virtual volume.

Generally, mirroring provides reduced latency and better bandwidth capabilities for high transaction workloads versus the latency offered by writing directly to the volume as long as the storage controller is able to keep up with the workloads. As the transaction workload increases, however, a point may come where a processor component of the storage controller's workload becomes saturated and/or a mirroring channel bandwidth component of the workload on the storage controller saturates, resulting in a reduction in performance due to increasing latency and decreasing bandwidth. Once the storage controller becomes saturated with either of these two workload components, the latency and maximum input/output operations per second (IOPs) may be available with a write-through mode that bypasses mirroring.

Because the incoming workload from hosts is variable, it is difficult to track. Further, users of storage controllers are typically required to choose between either write-through or mirroring caching modes. Accordingly, the potential remains for improvements that, for example, result in a storage system that may dynamically model workload conditions for a storage controller and enable dynamic transitioning between caching modes based on the dynamic modeling of workload conditions.

### BRIEF DESCRIPTION OF THE DRAWINGS

The present disclosure is best understood from the following detailed description when read with the accompanying figures.

FIG. 1 is an organizational diagram of an exemplary data storage architecture according to aspects of the present disclosure.

FIG. 2 is an organizational diagram of an exemplary controller architecture according to aspects of the present disclosure.

FIG. 3A is a diagram illustrating generation of a threshold curve according to aspects of the present disclosure.

FIG. 3B is a diagram illustrating generation of a threshold curve according to aspects of the present disclosure.

FIG. 4 is a flow diagram of a method dynamically changing a caching mode according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for improving the operation of storage array systems by providing for dynamic caching mode changes for input and output (I/O) operations. One example storage array system includes two storage controllers in a high availability configuration.

For example, a storage controller may monitor different characteristics representative of workload imposed by I/O operations (e.g., from one or more hosts) such as pertain to processor utilization and mirroring channel utilization. The storage controller inputs these monitored characteristics into a model of the system, which then provides a threshold curve. The threshold curve represents a boundary, below which mirroring mode still may provide better latency characteristics, and above which write-through mode may then provide better latency characteristics. The storage controller compares the monitored characteristics against the threshold curve.

When the storage controller is in the write-back mirroring mode, the storage controller determines to remain in that mode when the comparison shows that the characteristics fall below the threshold curve. Where the characteristics fall at or above the threshold curve, the storage controller may determine to transition to the write-through mode to improve latency, as this may correspond to situations where one or both of the processor utilization and the mirroring channel utilization may have become saturated. The storage controller may repeat this monitoring, comparing, and determining whether to switch over time, such as in a tight feedback loop (e.g., multiple times a second) to provide a responsive and dynamic caching mode system.

When the storage controller is in the write-through mode, the comparison may be against a lower threshold derived from the generated threshold (e.g., for hysteresis). The storage controller may determine to remain in that mode when the comparison shows that the characteristics are above the lower threshold. Where the characteristics fall at or below the lower threshold, the storage controller may determine to transition to the write-back mirroring mode to improve latency. This may be repeated as noted to provide a tight feedback loop.

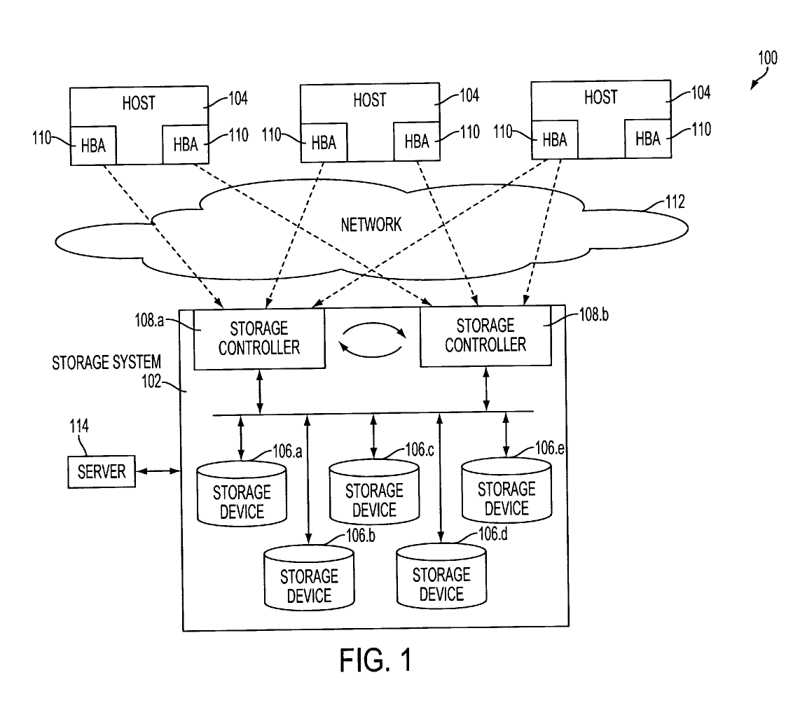

FIG. 1 illustrates a data storage architecture 100 in which various embodiments may be implemented. The storage architecture 100 includes a storage system 102 in communication with a number of hosts 104. The storage system 102 is a system that processes data transactions on behalf of other computing systems including one or more hosts, exemplified by the hosts 104. The storage system 102 may receive data transactions (e.g., requests to read and/or write data) from one or more of the hosts 104, and take an action such as reading, writing, or otherwise accessing the requested data. For many exemplary transactions, the storage system 102 returns a response such as requested data and/or a status indictor to the requesting host 104. It is understood that for clarity and ease of explanation, only a single storage system 102 is illustrated, although any number of hosts 104 may be in communication with any number of storage systems 102.

While the storage system 102 and each of the hosts 104 are referred to as singular entities, a storage system 102 or host 104 may include any number of computing devices and may range from a single computing system to a system cluster of any size. Accordingly, each storage system 102 and host 104 includes at least one computing system, which in turn includes a processor such as a microcontroller or a central processing unit (CPU) operable to perform various computing instructions. The instructions may, when executed by the processor, cause the processor to perform various operations described herein with the storage controllers 108.a, 108.b in the storage system 102 in connection with embodiments of the present disclosure. Instructions may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor may be, for example, a microprocessor, a microprocessor core, a microcontroller, an application-specific integrated circuit (ASIC), etc. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a network interface such as an Ethernet interface, a wireless interface (e.g., IEEE 802.11 or other suitable standard), or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106 and responds to one or more hosts 104's data transactions so that the storage devices 106 may appear to be directly connected (local) to the hosts 104. In various examples, the storage devices 106 include hard disk drives (HDDs), solid state drives (SSDs), optical drives, and/or any other suitable volatile or non-volatile data storage medium. In some embodiments, the storage devices 106 are relatively homogeneous (e.g., having the same manufacturer, model, and/or configuration). However, it is also common for the storage system 102 to include a heterogeneous set of storage devices 106 that includes storage devices of different media types from different manufacturers with notably different performance.

The storage system 102 may group the storage devices 106 for speed and/or redundancy using a virtualization technique such as RAID (Redundant Array of Independent/Inexpensive Disks). The storage system 102 also includes one or more storage controllers 108.a, 108.b in communication with the storage devices 106 and any respective caches (not shown). The storage controllers 108.a, 108.b exercise low-level control over the storage devices 106 in order to execute (perform) data transactions on behalf of one or more of the hosts 104. The storage controllers 108.a, 108.b are illustrative only; as will be recognized, more or fewer may be used in various embodiments. Having at least two storage controllers 108.a, 108.b may be useful, for example, for failover purposes in the event of equipment failure of either one. The storage system 102 may also be communicatively coupled to a user display for displaying diagnostic information, application output, and/or other suitable data.

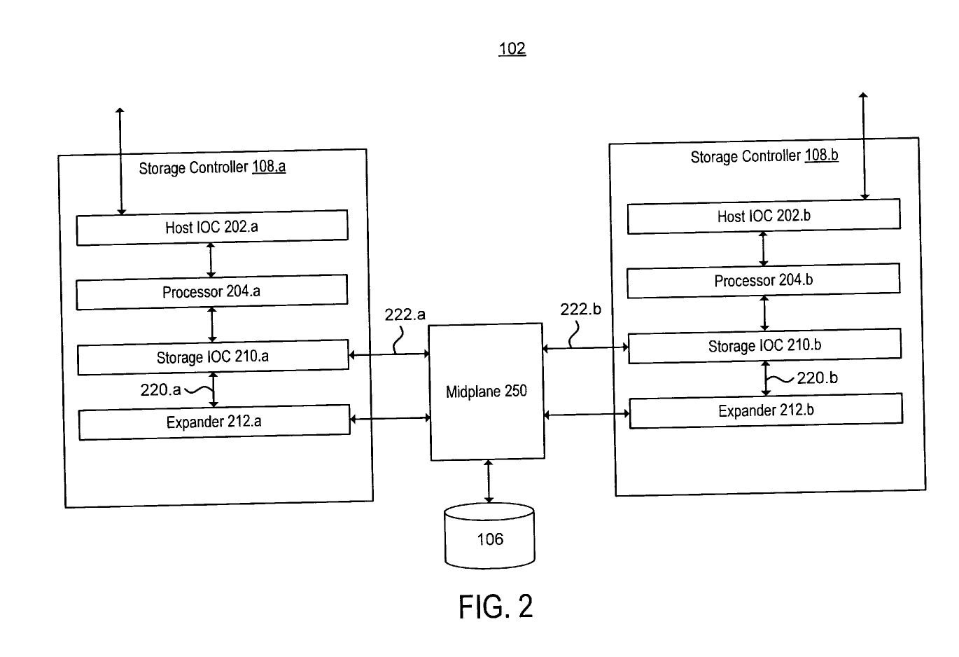

In the present example, storage controllers 108.a and 108.b are arranged as an HA pair. Thus, when storage controller 108.a performs a write operation for a host 104, storage controller 108.a may also sends a mirroring I/O operation to storage controller 108.b. Similarly, when storage controller 108.b performs a write operation, it may also send a mirroring I/O request to storage controller 108.a. Each of the storage controllers 108.a and 108.b has at least one processor executing logic to dynamically model workload conditions and, depending on the modeled workload conditions, dynamically change a caching mode based on the results of the modeled workload conditions. The particular techniques used in the writing and mirroring operations, as well as the caching mode selection, are described in more detail with respect to FIG. 2.

Moreover, the storage system 102 is communicatively coupled to server 114. The server 114 includes at least one computing system, which in turn includes a processor, for example as discussed above. The computing system may also include a memory device such as one or more of those discussed above, a video controller, a network interface, and/or a user I/O interface coupled to one or more user I/O devices. The server 114 may include a general purpose computer or a special purpose computer and may be embodied, for instance, as a commodity server running a storage operating system. While the server 114 is referred to as a singular entity, the server 114 may include any number of computing devices and may range from a single computing system to a system cluster of any size.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 110 in communication with a storage controller 108.a, 108.b of the storage system 102. The HBA 110 provides an interface for communicating with the storage controller 108.a, 108.b, and in that regard, may conform to any suitable hardware and/or software protocol. In various embodiments, the HBAs 110 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. The HBAs 110 of the hosts 104 may be coupled to the storage system 102 by a direct connection (e.g., a single wire or other point-to-point connection), a networked connection, or any combination thereof. Examples of suitable network architectures 112 include a Local Area Network (LAN), an Ethernet subnet, a PCI or PCIe subnet, a switched PCIe subnet, a Wide Area Network (WAN), a Metropolitan Area Network (MAN), the Internet, Fibre Channel, or the like. In many embodiments, a host 104 may have multiple communicative links with a single storage system 102 for redundancy. The multiple links may be provided by a single HBA 110 or multiple HBAs 110 within the hosts 104. In some embodiments, the multiple links operate in parallel to increase bandwidth.

To interact with (e.g., read, write, modify, etc.) remote data, a host HBA 110 sends one or more data transactions to the storage system 102. Data transactions are requests to read, write, or otherwise access data stored within a data storage device such as the storage system 102, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information. The storage system 102 executes the data transactions on behalf of the hosts 104 by reading, writing, or otherwise accessing data on the relevant storage devices 106. A storage system 102 may also execute data transactions based on applications running on the storage system 102 using the storage devices 106. For some data transactions, the storage system 102 formulates a response that may include requested data, status indicators, error messages, and/or other suitable data and provides the response to the provider of the transaction.

Data transactions are often categorized as either block-level or file-level. Block-level protocols designate data locations using an address within the aggregate of storage devices 106. Suitable addresses include physical addresses, which specify an exact location on a storage device, and virtual addresses, which remap the physical addresses so that a program can access an address space without concern for how it is distributed among underlying storage devices 106 of the aggregate. Exemplary block-level protocols include iSCSI, Fibre Channel, and Fibre Channel over Ethernet (FCoE). iSCSI is particularly well suited for embodiments where data transactions are received over a network that includes the Internet, a WAN, and/or a LAN. Fibre Channel and FCoE are well suited for embodiments where hosts 104 are coupled to the storage system 102 via a direct connection or via Fibre Channel switches. A Storage Attached Network (SAN) device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system that responds to file-level transactions. It is understood that the scope of present disclosure is not limited to either block-level or file-level protocols, and in many embodiments, the storage system 102 is responsive to a number of different memory transaction protocols.

In an embodiment, the server 114 may also provide data transactions to the storage system 102. Further, the server 114 may be used to configure various aspects of the storage system 102, for example under the direction and input of a user. Some configuration aspects may include definition of RAID group(s), disk pool(s), and volume(s), to name just a few examples.

This is illustrated, for example, in FIG. 2 which is an organizational diagram of an exemplary controller architecture of a storage system 102 introduced in FIG. 1 according to aspects of the present disclosure. The storage system 102 may include, for example, the first controller 108.a and the second controller 108.b, as well as the storage devices 106 (for ease of illustration, only one storage device 106 is shown). Various embodiments may include any appropriate number of storage devices 106. The storage devices 106 may include HDDs, SSDs, optical drives, and/or any other suitable volatile or non-volatile data storage medium.

Storage controllers 108.a and 108.b are redundant for purposes of failover, and the first controller 108.a will be described as representative for purposes of simplicity of discussion. It is understood that storage controller 108.b performs functions similar to that described for storage controller 108.a, and similarly numbered items at storage controller 108.b have similar structures and perform similar functions as those described for storage controller 108.a below.

As shown in FIG. 2, the first controller 108.a includes a host input/output controller (IOC) 202.a, a core processor 204.a, and a storage input output controllers (IOCs) 210.a (e.g., one or more, such as three). The storage IOC 210.a is connected directly or indirectly to expander 212.a by a communication channel 220.a. Storage IOC 210.a is connected directly or indirectly to midplane connector 250 by communication channel 222.a. Expander 212.a is connected directly or indirectly to midplane connector 250 as well.

The host IOC 202.a may be connected directly or indirectly to one or more host bus adapters (HBAs) 110 (FIG. 1) and provide an interface for the storage controller 108.a to communicate with the hosts 104. For example, the host IOC 202.a may operate in a target mode with respect to the host 104. The host IOC 202.a may conform to any suitable hardware and/or software protocol, for example including SAS, iSCSI, InfiniBand, Fibre Channel, and/or FCoE. Other suitable protocols include SATA, eSATA, PATA, USB, and FireWire.

The core processor 204.a may include a microprocessor, a microprocessor core, a microcontroller, an ASIC, a CPU, a digital signal processor (DSP), a controller, a field programmable gate array (FPGA) device, another hardware device, a firmware device, or any combination thereof. The core processor 204.a may include one or more multiple processing cores, and/or may also be implemented as a combination of computing devices, e.g., a combination of a DSP and a microprocessor, a plurality of microprocessors, one or more microprocessors in conjunction with a DSP core, or any other such configuration.

The storage IOC 210.a provides an interface for the storage controller 108.a to communicate with the storage devices 106 to write data and read data as requested. For example, the storage IOC 210.a may operate in an initiator mode with respect to the storage devices 106. The storage IOC 210.a may conform to any suitable hardware and/or software protocol, for example including iSCSI, Fibre Channel, FCoE, SMB/CFIS, SAMBA, and NFS.

For purposes of this example, storage controller 108.a executes storage drive I/O operations in response to I/O requests from a host 104. Storage controller 108.a is in communication with a port of storage devices 106 via storage IOC 210.a, expander 212.a, and midplane 250. Where the storage controller 108.a includes multiple storage IOCs 210.a, the I/O operation may be routed to the storage devices 106 via one of the multiple storage IOCs 210.a.

During a write operation, the particular process depends upon the caching mode of the storage controller 108.a, e.g. a write-back mirroring mode of operation or a write-through mode of operation. In the write-back mirroring mode, storage controller 108.a performs the write I/O operation to storage drive 106 and also sends a mirroring I/O operation to storage controller 108.b. Storage controller 108.a sends the mirroring I/O operation to storage controller 108.b via storage IOC 210.a, communications channel 222.a, and midplane 250. Similarly, storage controller 108.b is also performing its own write I/O operations and sending mirroring I/O operations to storage controller 108.a via storage IOC 210.b, communications channel 222.b, midplane 250, and IOC 210.a. Therefore, during normal operation of the storage system 102, communications channel 222.a may be heavily used (especially by mirroring I/O operations) and not have any spare bandwidth. Further or in the alternative, the mirroring operations may consume additional CPU cycles such that the CPU (e.g., of core processor 204.a) may become saturated.

In an embodiment, core processor 204.a executes code to provide functionality that dynamically monitors saturation conditions for the mirroring channel and/or the CPU, as well as other characteristics that may contribute to a dynamic determination to transition from write-back mirroring mode to write-through mode and vice-versa. For example, the core processor 204.a may cause the storage controller 108.a to monitor such things as the size of I/Os, the randomness of the I/O (e.g., whether there are any logical block addresses (LBAs) that are out of order from an overall I/O stream), the read/write mix of the system at that point in time, the number of read requests, the number of write requests, the number of cache hits (e.g., I/Os that do not require access to storage devices 106), the RAID level of the storage devices 106, the CPU utilization, the mirroring channel utilization, and the number of free cache blocks available when a write comes in, the no-wait cache hit count (the number of times that the system loops to wait for available cache blocks the number of times that the system stalls to wait for available blocks), to name just a few examples.

In an embodiment, the core processor 204.a may monitor the characteristics, or some subset thereof, multiple times a second (e.g., every ⅛ of a second, or more or less frequently) to name an example. From the perspective of a user, this may be referred to as a real-time or near-real-time modeling operation, since there is no perceptible delay in user observation. Further, these monitored values may be averaged (for each of the monitored characteristics) over a fixed period of time to effectively provide a moving window of average values (e.g., an 8 second window to name just one example).

The core processor 204.a may input some or all of these monitored characteristics of the storage controller 108.a into a model of the storage controller 108.a (e.g., a model of different performance characteristics of the storage controller 108.a based on the inputs about monitored characteristics of the storage controller 108.a). The model may take some or all of these inputs as variables in creating an output threshold that the core processor 204.a may then use to compare one or more characteristics of the storage controller 108.a against.

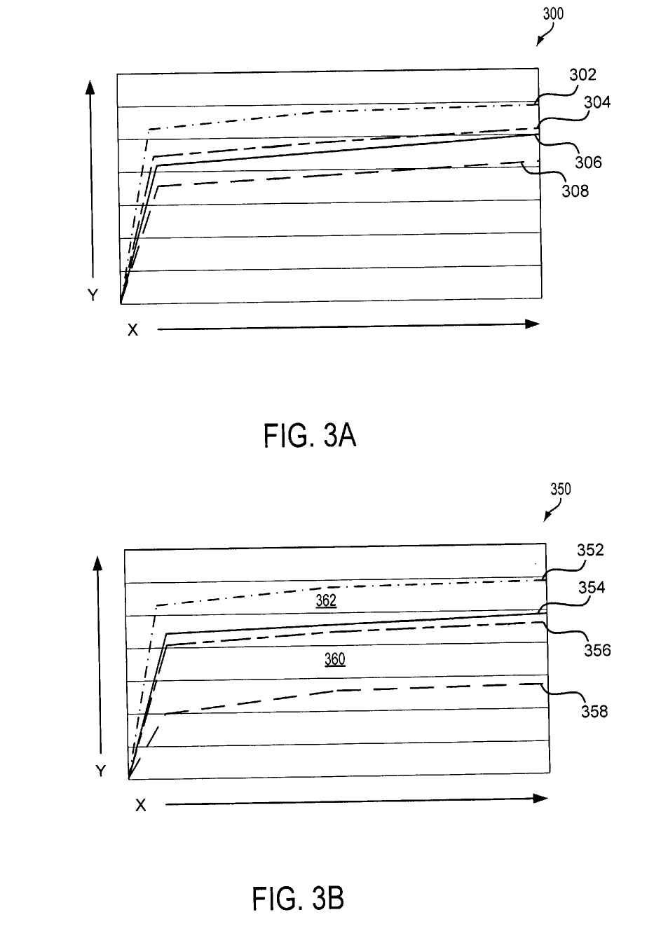

In an embodiment, the output threshold may take the form of a threshold curve. For example, FIG. 3A is a diagram 300 illustrating generation of multiple input curves for several inputs that will be used for the generation of a threshold curve according to aspects of the present disclosure. In particular FIG. 3A illustrates multiple inputs as modeled as individual curves before combining with each other and other inputs, with the X axis corresponding to a transfer size of I/O and the Y axis corresponding to a transfer rate, for example in MB/s (resulting in a curve that illustrates a maximum number of I/Os and block sizes achievable by the controller). In an embodiment, the individual curves may use pre-determined equations to model the different characteristics of the system. In an alternative embodiment, the individual curves may be determined using a curve-fitting approach, such as least-squares, in order to model the respective characteristics.

As an example, the curve 302 may represent a write limit based on the RAID level as the input, the curve 304 may represent the write limit based on the randomness of the I/O as the input, the curve 308 may represent the write limit based on the mirroring channel utilization as the input, and the curve 306 may represent a composite write limit based on the other inputs 302, 304, and 308. As will be recognized, this is exemplary only; other inputs may be included in addition to, or in substitution of all or part of those mentioned above, the exemplary inputs mentioned.

In an embodiment, each input may weight or otherwise influence a given equation used to generate the curves 302, 304, 306, and 308. For example, the following pseudo-equation illustrates an exemplary combination:

A*f₁(x)+B*f₂(x)+C*f₃(x)=f₄(x),

where A*fᵢ(x) may represent the curve 302 corresponding to the RAID level, B*f₂(x) may represent the curve 304 corresponding to the randomness of the I/O, and C*f₃(x) may represent the curve 308 corresponding to the mirroring channel utilization. A (RAID level), B (randomness of the I/O), and C (mirroring channel utilization) may represent the influence that the monitored characteristics have on their respective curves, and are for illustration only. These may combine to result in f₄(x) that represents the curve 306, corresponding to a composite write limit in FIG. 3A. As can be seen, the different inputs may influence the resulting composite write limit (threshold) curve 306 so that it increases or decreases (and/or changes slope or other related characteristics) depending on the values of the specific inputs.

Turning now to FIG. 3B, a diagram 350 is illustrated that shows the generation of multiple input curves for several inputs used for the generation of a threshold curve according to aspects of the present disclosure. As illustrated in FIG. 3B, additional inputs may be considered to arrive at a final output threshold. The diagram 350 may have the same axes as discussed above with respect to FIG. 3A. The diagram 350 may include curve 352 that corresponds to a first input, such as a cache access limit (e.g., a number of cache hits as the input, as adjusted by the I/O size and mirroring characteristic), curve 356 that corresponds to a second input, such as a read limit (e.g., a number of read requests as the input, as adjusted by the I/O size and the randomness of the I/O), and curve 358 may correspond to a third input, such as a write limit (e.g., the composite write limit curve 306 from FIG. 3A). Curve 354 may correspond to a final write limit based on the other input curves 352, 356, and 358. As will be recognized, this is exemplary only; other inputs may be included in addition to, or in substitution of all or part of those mentioned above, the exemplary inputs mentioned. Further, the functionality represented in FIGS. 3A and 3B may be combined in a single diagram.

In an embodiment, each input may correspond to a weight for a given equation used to generate the curves 352, 354, 356, and 358. For example, the following pseudo-equation illustrates an exemplary combination:

f₄(x)+D*f₅(x)+E*f₆(x)=f₇(x),

where f₄(x) may represent the composite write limit curve 306 from FIG. 3A (curve 358 in FIG. 3B), D*f₅(x) may represent the curve 352 corresponding to the cache access limit, and E*f₆(x) may represent the curve 356 corresponding to the read limit. These may be combined to result in f₇(x) representing the curve 354 corresponding to the final write limit in FIG. 3B. The inputs' ability to influence the equations for the model illustrate that the resulting final write limit, referred to herein as a threshold curve (e.g., curve 354 of FIG. 3B), which provides a threshold under which (region 360) write-back mirroring remains the optimal caching mode, and above which (region 362) write-through may become the optimal caching mode.

Returning now to FIG. 2, the core processor 204.a executes code to provide functionality that takes the result from the model, e.g. the threshold curve 354, and compares one or more monitored characteristics of the storage controller 108.a against the threshold curve 354. For example, independent of the model that produces the threshold curve 354, the core processor 204.a may create a workload value, such as generated from the I/O size, read/write mix, RAID level, and randomness of the I/O measures, as well as a mirroring channel utilization value, to create a composite value expressed in terms of the axes of the curves produced and discussed above with respect to FIGS. 3A and 3B. For example, for a current transfer size, the monitored characteristics including at least mirror channel utilization and CPU utilization may be used to create the composite value.

The core processor 204.a determines specifically whether the composite value falls above, at, or below the threshold curve 354. If the storage controller 108.a is currently in the write-back-mirroring mode, and the core processor 204.a determines that the composite value is below the threshold curve 354 in region 360, then the core processor 204.a may determine to remain in write-back mirroring mode as this may continue to provide the best latency option (over switching to write-through mode). If the storage controller 108.a, while in write-back mirroring mode, determines that the composite value is at the curve 354 or above in region 362, this may correspond to situations where the CPU utilization and/or the mirror channel utilization has saturated and is causing an increase in latency. As a result, the core processor 204.a may determine to transition from write-back mirroring mode to write-through mode.

As this is a continuing feedback loop, the core processor 204.a repeats the above process over time. As will be recognized, since the inputs to the model are from what is monitored at that time with respect to the workload, the resulting threshold curve is dynamic in that it changes over time in response to the different workload demands on the storage controller 108.a at any given point in time.

Continuing with the example, once the storage controller 108.a is in the write-through mode, the core processor 204.a continues to monitor the different characteristics, input those monitored values into the model, generate a threshold curve, and compare some subset of the monitored characteristics against the threshold curve. In an embodiment, when determining whether to switch to the write-back mirroring mode from the write-through mode, the core processor 204.a may further execute code to provide functionality that causes the core processor 204.a to add a delta to the threshold curve. For example, a negative delta value may be added to the threshold curve (e.g., any point on the threshold curve or the curve generally). Thus, when the one or more monitored characteristics are compared against the modified threshold curve, a transition back to the write-back mirroring mode may not be triggered until the plotted characteristic is some distance equal to the negative delta below the threshold curve (which may also be referred to as a second threshold curve derived from the first threshold curve 354), such as into the region 360 of FIG. 3B below the threshold curve 354. This provides an element of hysteresis into the feedback control loop so that transitions are better controlled to result in improved performance of the storage controller 108.a (e.g., in providing more IOPs per second and thus particular IOPs with reduced latency).

The above description provides an illustration of the operation of the core processor 204.a of storage controller 108.a. It is understood that storage controller 108.b performs similar operations. Specifically, in a default mode of operations, storage controller 108.b may perform write-back mirroring (e.g., be in a write-back mirror mode). It monitors some or all of the same characteristics discussed above and dynamically changes caching modes where the current value of the characteristic(s) is at or above the threshold curve (to write-through from write-back mirroring) or some amount below the threshold curve (to write-back mirroring from write-through). Therefore, storage controller 108.b may dynamically switch between caching modes to optimize IOPs performance.

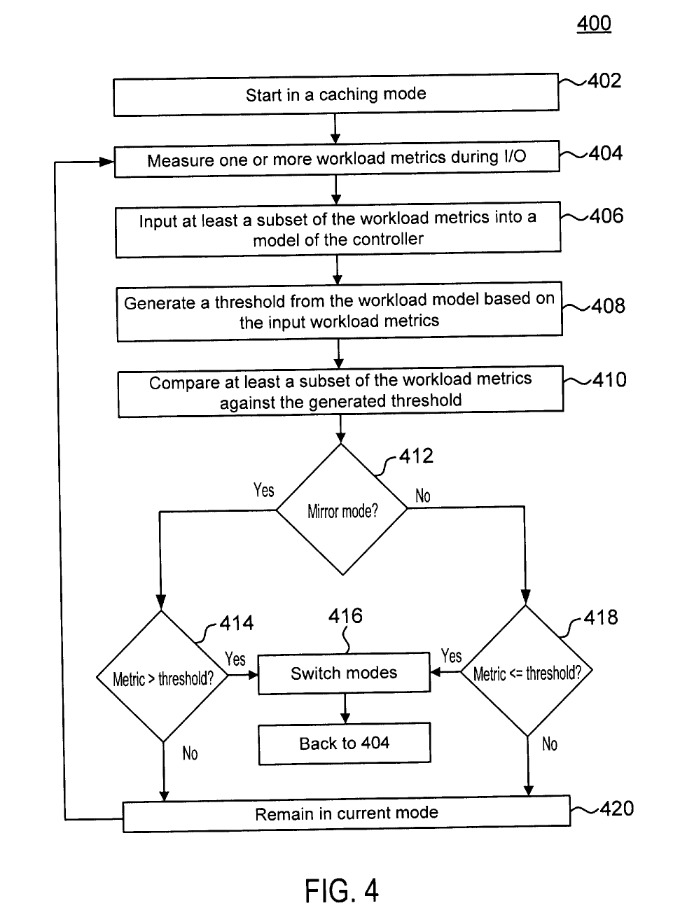

Turning now to FIG. 4, a flow diagram of a method 400 of dynamically monitoring workload and dynamically switching between caching modes is illustrated according to aspects of the present disclosure. In an embodiment, the method 400 may be implemented by one or more processors of one or more of the storage controllers 108 of the storage system 102, executing computer-readable instructions to perform the functions described herein. Reference will be made to a general storage controller 108 and processor 204 for simplicity of illustration. It is understood that additional steps can be provided before, during, and after the steps of method 400, and that some of the steps described can be replaced or eliminated for other embodiments of the method 400.

At block 402, the storage controller 108 may start in a write-back mirroring mode of operation. This may be useful as mirroring may provide less latency than write-through (e.g., to storage devices 106 of FIG. 1) at certain workloads. In an alternative embodiment, the storage controller 108 may start in a write-through mode instead without departing from the scope of the present disclosure.

At block 404, the processor 204 measures one or more workload metrics during I/O operations, for example some or all (or others) of those characteristics discussed above with respect to FIGS. 2, 3A, and 3B. The processor 204 may perform these measurements (monitoring) during operation, or in other words as the storage controller 108 receives I/O operations from one or more hosts 104.

At block 406, the processor 204 inputs the measured workload metrics into a model, e.g. a model of the storage controller 108 that models the performance of the storage controller 108 under a workload.

At block 408, the processor 204 generates a threshold, such as a threshold curve (e.g., threshold curve 354 of FIG. 3B), that is based on the measured workload metrics that were input into the model at block 406. In an embodiment, the processor 204 may subtract some delta amount from the generated threshold curve when the storage controller 108 is in the write-through mode, so that some hysteresis is built into the control loop. Thus, this modified threshold, a second threshold curve in some embodiments, is less than the initially generated or first threshold curve.

At block 410, the processor 204 compares at least a subset of the measured workload metrics, such as the CPU utilization and mirroring channel utilization to name some examples, against the generated threshold curve from block 408 (the first threshold curve when in the write-back mirroring mode, the second threshold curve when in the write-through mode), to determine whether the measured workload metrics, in combination or separately, fall above or below the (first or second, depending upon mode) threshold curve.

If the storage controller 108 is in the mirroring mode, then the method 400 proceeds from decision block 412 to decision block 414.

At decision block 414, if the result of the comparison at block 410 is that the measured workload metrics used in the comparison are greater than (or, in an embodiment, greater than or equal to) the first threshold curve, then the method continues to block 416. At block 416, the processor 204 causes the storage controller 108 to switch from the write-back mirroring mode to the write-through mode, as some aspect of the system has saturated (e.g., the CPU or the mirroring channel, to name some examples) and switching to write-through may improve latency from the saturation condition.

After switching caching modes at block 416, the method 400 returns to block 404 to continue the monitoring and comparing, e.g. in a tight feedback loop.

Returning to decision block 414, if the result of the comparison at block 410 is that the measured workload metrics are less than the first threshold curve, then the method 400 continues to block 420. At block 420, the storage controller 108 remains in the current caching mode, here the write-back mirroring mode. From block 420, the method 400 returns to block 404 to continue the monitoring and comparing, e.g. in a tight feedback loop.

Returning now to decision block 412, if the storage controller 108 is in the write-through mode, then the method 400 proceeds to decision block 418.

At decision block 418, if the result of the comparison at block 410 is that the measured workload metrics used in the comparison are less than (or less than or equal to in an embodiment, since hysteresis is already built in) the second threshold curve, then the method 400 continues to block 416, where the caching mode switches to the write-back mirroring mode and returns to block 404 as discussed above.

Returning to decision block 418, if the result of the comparison at block 410 (in the write-through mode) is that the measured workload metrics are greater than the second threshold curve, then the method 400 continues to block 420 as discussed above.

The scope of embodiments is not limited to the actions shown in FIG. 4. Rather, other embodiments may add, omit, rearrange, or modify various actions. For instance, in a scenario wherein the storage controller is in an HA pair with another storage controller, the other storage controller may perform the same or similar method 400.

Various embodiments described herein provide advantages over prior systems and methods. For instance, a conventional system that uses write-back mirroring may unnecessarily delay requested I/O operations in situations where saturation in CPU utilization and/or the mirroring channel utilization has occurred. Similarly, a conventional system that attempts to switch between modes does so by toggling between modes in a manner that causes noticeable periodic disruptions in the storage controller's performance (e.g., noticeable change in latency during toggling to see if the other mode will provide better at I/O operations). Various embodiments described above use a dynamic modeling and switching scheme to take advantage of workload monitoring and using write-through instead of write-back mirroring where appropriate. Various embodiments improve the operation of the storage system 102 of FIG. 1 by reducing or minimizing delay associated with I/O operations and/or efficiency of the processors of the storage controllers. Put another way, some embodiments are directed toward a problem presented by the architecture of some storage systems, and those embodiments provide dynamic modeling and caching mode switching techniques that may be adapted into those architectures to improve the performance of the machines used in those architectures.

The present embodiments can take the form of a hardware embodiment, a software embodiment, or an embodiment containing both hardware and software elements. In that regard, in some embodiments, the computing system is programmable and is programmed to execute processes including the processes of method 400 discussed herein. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include for example non-volatile memory including magnetic storage, solid-state storage, optical storage, cache memory, and Random Access Memory (RAM).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
in a group of storage controllers having a first storage controller and a second storage controller operable to communicate by a mirroring channel, operating the first storage controller and the second storage controller in a mirroring cache mode;
comparing a utilization of the mirroring channel to a first threshold; and
changing from the mirroring cache mode to a write-through mode based at least in part on a result of the comparing.

2. The method of claim 1, further comprising:
after changing from the mirroring cache mode to the write-through mode, changing from the write-through mode to the mirroring cache mode based on a change in the utilization of the mirroring channel.

3. The method of claim 1, further comprising:
after changing from the mirroring cache mode to the write-through mode, changing from the write-through mode to the mirroring cache mode in response to comparing the utilization of the mirroring channel to a second threshold that is lower than the first threshold.

4. The method of claim 1, wherein changing from the mirroring cache mode to the write-through mode is further based in part on a level of CPU utilization.

5. The method of claim 1, wherein changing from the mirroring cache mode to the write-through mode is further based in part on a number of free cache blocks when a write operation is received.

6. The method of claim 1, wherein changing from the mirroring cache mode to the write-through mode is further based in part on a size of a write operation received from a host device.

7. The method of claim 1, wherein the first threshold corresponds to a number of write operations limit on the first storage controller during the mirroring cache mode.

8. The method of claim 1, wherein the first threshold corresponds to a write operations block size limit on the first storage controller during the mirroring cache mode.

9. A non-transitory machine readable medium having stored thereon instructions for performing a method comprising machine executable code which when executed by at least one machine, causes the machine to:
operate a first storage controller and a second storage controller in a mirroring cache mode that includes the first storage controller sending a plurality of write operations over a communication channel to the second storage controller;
monitor a utilization of the communication channel during the mirroring cache mode; and
change from the mirroring cache mode to a write-through mode based at least in part on a monitored level of utilization of the communication channel.

10. The non-transitory machine readable medium of claim 9, having further instructions causing the machine to: change from the write-through mode to the mirroring cache mode based on a change in the monitored level of utilization of the communication channel after changing from the mirroring cache mode to the write-through mode.

11. The non-transitory machine readable medium of claim 9, having further instructions causing the machine to: change from the write-through mode to the mirroring cache mode in response to comparing the monitored level of utilization of the communication channel to a threshold after changing from the mirroring cache mode to the write-through mode.

12. The non-transitory machine readable medium of claim 9, wherein changing from the mirroring cache mode to the write-through mode is further based in part on monitoring a level of CPU utilization.

13. The non-transitory machine readable medium of claim 9, wherein changing from the mirroring cache mode to the write-through mode is further based in part on monitoring a number of free cache blocks.

14. The non-transitory machine readable medium of claim 9, wherein changing from the mirroring cache mode to the write-through mode is further based in part on monitoring sizes of the plurality of write operations.

15. The non-transitory machine readable medium of claim 9, having further operations causing the machine to:
compare the monitored level of utilization of the communication channel to a threshold, wherein the threshold corresponds to a number of write operations limit on the first storage controller during the mirroring cache mode.

16. The non-transitory machine readable medium of claim 9, having further operations causing the machine to:
compare the monitored level of utilization of the communication channel to a threshold, wherein the threshold corresponds to a write operations block size limit on the first storage controller during the mirroring cache mode.

17. A computing device comprising:
a memory containing machine readable medium comprising machine executable code having stored thereon instructions for performing a method of dynamically adjusting a caching mode of the computing device;
a processor coupled to the memory, the processor configured to execute the machine executable code to cause the processor to:
operate a first storage controller and a second storage controller in a mirroring cache mode that includes the first storage controller sending a plurality of write operations over a communication channel to the second storage controller;
monitor a utilization of the communication channel during the mirroring cache mode; and
change from the mirroring cache mode to a write-through mode based at least in part on a monitored level of utilization of the communication channel.

18. The computing device of claim 17, wherein the processor is further configured to execute the machine executable code to cause the processor to: change from the write-through mode to the mirroring cache mode based on a change in the monitored level of utilization of the communication channel after changing from the mirroring cache mode to the write-through mode.

19. The computing device of claim 17, wherein the processor is further configured to execute the machine executable code to cause the processor to: change from the write-through mode to the minoring cache mode in response to comparing the monitored level of utilization of the communication channel to a threshold after changing from the minoring cache mode to the write-through mode.

20. The computing device of claim 17, wherein the first storage controller and the second storage controller are configured as a high availability (HA) pair.
